(19) United States
(12) Patent Application Publication
(10) Pub. No.: US 2019/0275910 A1
(43) Pub. Date: Sep. 12, 2019

(54) CHARGING MANAGEMENT DEVICE, PARKING LOT, AND COMPUTER-READABLE STORAGE MEDIUM

(71) Applicant: HONDA MOTOR CO.,LTD., Tokyo (JP)

(72) Inventors: Katsuya INOUE, Saitama (JP); Kei MACHIDA, Tokyo (JP)

(21) Appl. No.: 16/288,106

(22) Filed: Feb. 28, 2019

(30) Foreign Application Priority Data
Mar. 7, 2018 (JP) 2018-041344

(51) Int. Cl. B60L 53/68; B60L 53/66; B60L 53/67; B60L 53/62; B60L 55/00; G06Q 10/06; G06Q 50/06

(52) U.S. Cl. CPC B60L 53/68; B60L 53/665; B60L 53/67; G06Q 50/06; B60L 55/00; G06Q 10/06316; B60L 53/62

(57) ABSTRACT

A charging management device includes: an environment information acquiring unit that acquires charging environment information indicating a charging environment of each of a plurality of vehicles parked in a parking lot; an order deciding unit that decides an order in which the plurality of vehicles are charged, taking into consideration the charging environment indicated by the charging environment information; and a charging management unit that causes the plurality of vehicles to be charged according to the order decided by the order deciding unit. A parking lot including the above-mentioned charging management device may be provided. A program for causing a computer to function as the above-mentioned charging management device may be provided.

The contents of the following patent application are incorporated herein by reference:

Japanese Patent Application No. 2018-041344 filed on Mar. 7, 2018.

### BACKGROUND

### 1. Technical Field

The present invention relates to a charging management device, a parking lot and a computer-readable storage medium.

### 2. Related Art

Systems for charging vehicles are known (see the following Patent Literatures, for example).

### PRIOR ART LITERATURES

### Patent Literatures

[Patent Literature 1] Japanese Patent Application Publication No. 2011-254593

[Patent Literature 2] Japanese Patent Application Publication No. 2006-288034

[Patent Literature 3] Japanese Patent Application Publication No. 2016-103938

[Patent Literature 4] Japanese Patent Application Publication No. H10-51960

[Patent Literature 5] Japanese Patent Application Publication No. 2015-50877

### SUMMARY

In a parking space for a number of vehicles like a parking lot, it has conventionally been not easy to appropriately decide the order in which the vehicles are charged.

### BRIEF DESCRIPTION OF THE DRAWINGS

FIG. 1 schematically illustrates an exemplary overall configuration of a parking lot 10.

FIG. 2 schematically illustrates the functional block configuration of a charging management device 100, along with a vehicle 40, a connector 14, and a charging cable 18.

FIG. 3 illustrates, in a table format, exemplary vehicle management information managed at the charging management device 100.

FIG. 4 is an exemplary flowchart showing processes performed at the charging management device 100.

FIG. 5 schematically illustrates another exemplary usage form of parking sections.

FIG. 6 generally illustrates an exemplary computer 1000 to function as the charging management device 100.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

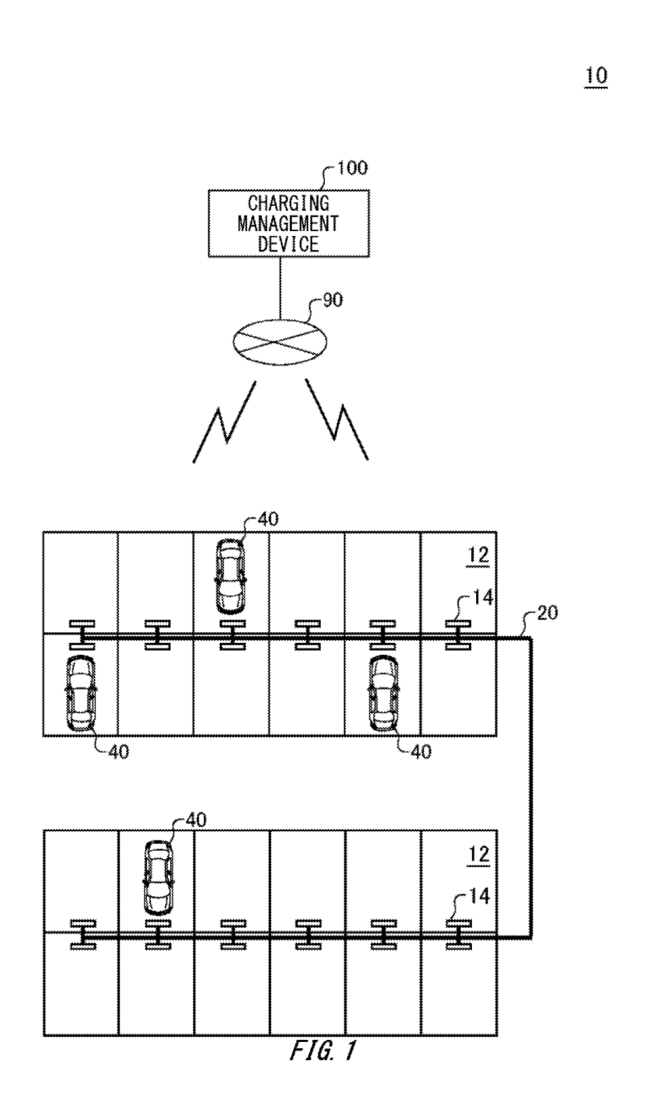

FIG. 1 schematically illustrates an exemplary overall configuration of a parking lot 10. The parking lot 10 includes a plurality of parking sections 12, a plurality of connectors 14, a power line 20 and a charging management device 100. A network 90 connects the charging management device 100 with vehicles 40 using the parking lot 10.

The network 90 may be any network. For example, the network 90 may include at least any of the Internet, a mobile phone network such as a so-called 3G (3rd Generation), LTE (Long Term Evolution), 4G (4th Generation), or 5G (5th Generation) network, a public wireless LAN (Local Area Network), and a private network. A wired connection may be established between the charging management device 100 and the network 90. A wireless connection may be established between the charging management device 100 and the network 90. Wireless connections may be established between the network 90 and the vehicles 40. Wired connections may be established between the network 90 and the vehicles 40. Power lines may connect the network 90 and vehicles 40.

In the parking lot 10, the connectors 14 are each provided to one of the parking sections 12. The plurality of connectors 14 are connected through the power line 20. The vehicles 40 are electric vehicles. The electric vehicles may include battery electric vehicles (BEV), and plug-in hybrid electric vehicles (PHEV). The vehicles 40 may be any type of vehicles as long as the vehicles can be charged from the outside. After stopping vehicles 40 at the parking sections 12, users of the parking lot 10 connect charging cables to the connectors 14. Thereby, the vehicles 40 are connected with other vehicles 40 via the power line 20. Note that connections between the power line 20 and the vehicles 40 may enable contactless power transfer.

The charging management device 100 manages charging performed between vehicles 40 and other vehicles 40. The vehicles 40 perform power transfer directly with the other vehicles 40 via the power line 20 according to control by the charging management device 100. The vehicles 40 and the other vehicles 40 perform power transfer directly in a one-to-one correspondence.

Specifically, the charging management device 100 acquires from a vehicle-side device provided to each vehicle 40: charging environment information including information indicating the charging environment of the vehicle 40; the SOC of a battery provided to the vehicle 40; an amount of charging power which is an amount of power by which the battery needs to be charged or a dischargeable power amount which is an amount of power that can be discharged from the battery; and a length of time of scheduled usage of the parking lot 10. The charging environment information includes information indicating whether or not a charging facility is available at the home of the owner of the vehicle 40 or a parking lot of his/her workplace. Note that the vehicle-side device includes an in-vehicle device such as a car navigation device. The vehicle-side device includes, in addition to the in-vehicle device, a terminal such as a mobile terminal such as a smartphone.

The charging management device 100 decides the order in which the vehicles 40 are charged. For example, the charging management device 100 decides the order of charging such that a vehicle 40 of an owner to whom a charging facility is not available at his/her home or a parking lot of his/her workplace can be charged earlier than a vehicle 40 of an owner to whom a charging facility is available at his/her home or a parking lot of his/her workplace. In addition, the charging management device 100 decides the order of charging such that a vehicle 40 with a lower SOC is charged earlier.

The charging management device 100 selects a to-be-charged vehicle from vehicles 40 in the decided order. Upon selection of a to-be-charged vehicle 40, as another vehicle 40 to be a power supplier for the to-be-charged vehicle 40, the charging management device 100 decides a vehicle 40 having a dischargeable power amount matching the amount of charging power of the to-be-charged vehicle 40. The charging management device 100 performs control of the to-be-charged vehicle 40 and the power supplier vehicle 40 such that power transfer is performed directly between the power supplier vehicle 40 and the to-be-charged vehicle 40 via the power line 20 to charge the battery of the to-be-charged vehicle 40.

According to the charging management device 100, the order in which vehicles 40 parked in the parking lot 10 are charged can be decided taking into consideration the charging environments of the owners of the vehicles 40. Because of this, vehicles 40 of owners not having charging facilities at their homes or the like can be given higher priorities in terms of the order of charging. In addition, since vehicles 40 can perform power transfer directly therebetween, it is not necessary to provide large-sized power transformation equipment or power source equipment in the parking lot 10.

In the present embodiment, it is supposed that the parking lot 10 is a parking lot associated with a commercial facility. The parking lot 10 may be a parking lot where users of the commercial facility can use. In addition, the parking lot 10 may be constituted by a plurality of parking lots having relatively small-sized parking spaces. In places where it is difficult to acquire a single sufficiently large parking space, for example in areas around railway stations or the like, parking lots having parking spaces for approximately several vehicles to a dozen of vehicles may be electrically connected, and those parking lots can be seen as a parking lot having a moderate size. It is likely that parking lot users of a parking lot in an area around a railway station use another means of transportation after parking their vehicles, and it is likely that they can spare the time necessary for charging/discharging as in the cases where they park their vehicles in parking lots of commercial facilities.

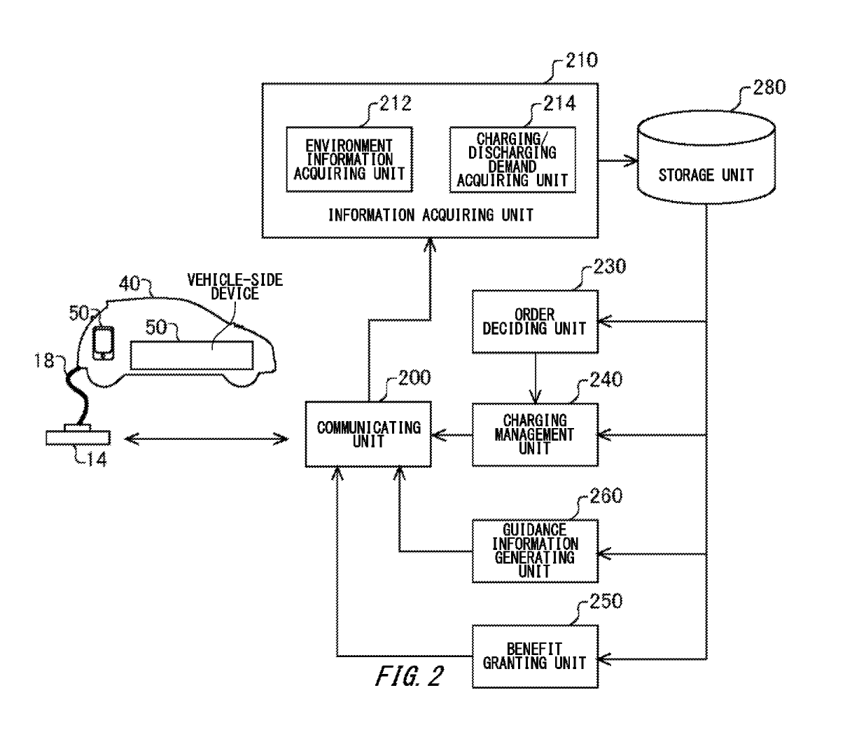

FIG. 2 schematically illustrates the functional block configuration of the charging management device 100, along with a vehicle 40, a connector 14, and a charging cable 18. The charging management device 100 has a communicating unit 200, an information acquiring unit 210, an order deciding unit 230, a charging management unit 240, a benefit granting unit 250, a guidance information generating unit 260, and a storage unit 280. The information acquiring unit 210 has an environment information acquiring unit 212, and a charging/discharging demand acquiring unit 214.

The communicating unit 200 is involved in communication with a vehicle-side device 50. Information acquired by the communicating unit 200 is supplied to the information acquiring unit 210. At the information acquiring unit 210, the environment information acquiring unit 212 acquires charging environment information indicating the charging environment of each of a plurality of vehicles 40 parked in the parking lot 10.

The order deciding unit 230 decides the order in which the plurality of vehicles 40 are charged, taking into consideration the charging environments indicated by the charging environment information. The charging management unit 240 causes the plurality of vehicles to be charged according to the order decided by the order deciding unit 230. Thereby, the vehicles 40 can be charged in an appropriate order according to the charging environments of the vehicles 40.

At the information acquiring unit 210, the charging/discharging demand acquiring unit 214 acquires in advance: an amount of charging power requested by each of vehicles 40 that are among the plurality of vehicles 40 and request charging; and a dischargeable power amount of each of dischargeable vehicles 40 among the plurality of vehicles 40. Based on the information acquired by the charging/discharging demand acquiring unit 214, the charging management unit 240 selects, from among the plurality of vehicles, a second vehicle which is a vehicle that has sufficient power for discharging an amount of power matching an amount of charging power requested by a first vehicle which is a vehicle selected according to an order, and causes the first vehicle to be charged with power discharged from the second vehicle.

At the information acquiring unit 210, the charging/discharging demand acquiring unit 214 acquires in advance: an amount of charging power requested by each of the vehicles 40 requesting charging; a charging period during which the charging is requested to be carried out; and a dischargeable power amount and a dischargeable period of each of the dischargeable vehicles 40. Based on the information acquired by the charging/discharging demand acquiring unit 214, the charging management unit 240 selects, as a second vehicle from among a plurality of vehicles 40, a vehicle that has sufficient power for discharging the amount of charging power requested by a first vehicle in the charging period.

If a dischargeable vehicle 40 remains stopped in the parking lot 10 for a certain dischargeable period, the benefit granting unit 250 grants a benefit related to a usage fee of the parking lot 10 or usage of a commercial facility associated with the parking lot 10. For example, the benefit granting unit 250 discounts the usage fee of the parking lot.

The first vehicle and second vehicle are connected through the power line 20 provided in the parking lot, and power can be directly transferred between the first vehicle and the second vehicle through the power line. In the parking lot 10, power storage devices other than batteries provided to vehicles 40 may not necessarily be connected to the power line 20.

The guidance information generating unit 260 generates information for guiding a vehicle 40 that has sufficient power for discharging an amount of power matching an amount of charging power requested by a vehicle 40 requesting charging, to a parking position near a position where the vehicle requesting charging is parked. Thereby, a vehicle 40 demanding charging and a vehicle 40 demanding discharging can charge and discharge at nearby positions. Note that the vehicle 40 demanding charging and the vehicle 40 demanding discharging can charge and discharge as long as they are connected through the power line 20, and need not be parked at nearby positions that are physically separated only by a short distance.

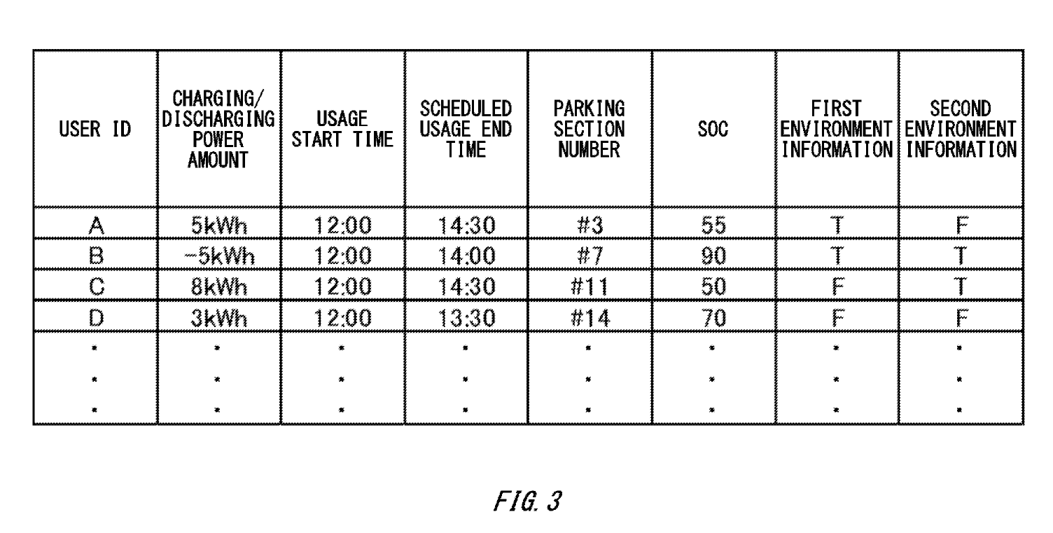

FIG. 3 illustrates, in a table format, exemplary vehicle management information managed at the charging management device 100. The vehicle management information includes: user IDs; charging/discharging power amounts; usage start times; scheduled usage end times; parking section numbers; SOCs; first environment information indicating whether or not charging facilities are available at the homes of owners of vehicles 40; and second charging environment information indicating whether or not charging facilities are available at workplaces of owners of vehicles 40. The user IDs, charging/discharging power amounts, scheduled end times, first charging environment information, and second charging environment information are information acquired by the charging/discharging demand acquiring unit 214. The user IDs are information for identifying users of the parking lot 10.

A charging/discharging power amount indicates an amount of charging power required by a vehicle 40 or a dischargeable power amount at a vehicle 40. In FIG. 3, amounts of charging power are expressed as positive values, and dischargeable power amounts are expressed as negative values. A scheduled usage end time is a time at which usage of the parking lot 10 is scheduled to be ended. An amount of charging power or dischargeable power amount, and a scheduled end time are set by a driver of a vehicle 40 before or when he/she starts usage of the parking lot 10. For example, a driver of a vehicle 40 inputs an amount of charging power or dischargeable power amount, and a scheduled usage end time to a vehicle-side device 50. A user ID, first charging environment information, and second charging environment information are preset in the vehicle-side device 50.

First charging environment information indicates whether or not a charging facility is available at the home of the owner of a vehicle 40. Second charging environment information indicates whether or not a charging facility is available at a workplace of the owner of a vehicle 40. In FIG. 3, “F” indicates charging facilities are available, and “T” indicates charging facility are available.

If the charging cable 18 is connected to the connector 14, communication becomes possible between the vehicle-side device 50 and the charging management device 100 through the charging cable 18 and power line 20. If the charging cable 18 is connected to the connector 14, the user ID set in the vehicle-side device 50 and the SOC information about a battery acquired by the vehicle-side device 50 from the vehicle 40 are transmitted to the charging management device 100 along with a parking section number allocated to the connector 14. At the time when the vehicle 40 passes through an entrance gate of the parking lot 10, the usage start time is transmitted to the charging management device 100 through a mobile terminal or the like for which a user ID is set. The vehicle information collected by the charging management device 100 is stored in the storage unit 280. Note that the usage start time may be set to a time point when the charging cable is connected to the connector 14.

Based on SOCs of batteries provided to vehicles 40, first charging environment information, and second charging environment information, the order deciding unit 230 decides the order in which vehicles 40 are charged. The order deciding unit 230 decides priorities about charging of vehicles 40, for example, in a manner that if the SOC is lower than 50%, the priority 1 is given, if the SOC is 50% or higher and lower than 75, the priority 2 is given, and if the SOC is 75% or higher, the priority 3 is given. The order deciding unit 230 decides the order such that a vehicle with a higher priority is charged earlier. Note that the amount of power for a certain SOC depends on a battery mounted in a vehicle. Accordingly, priorities can be decided taking into consideration not only the values of SOCs, but also actual amounts of remaining power, distances that vehicles can travel that are determined individually for the vehicles according to current SOCs, or the like.

The order deciding unit 230 decides an order of charging taking into consideration first charging environment information and second charging environment information if vehicles 40 are given the same priority. For example, the order deciding unit 230 decides an order such that a vehicle 40 for which first charging environment information and second charging environment information are set to F is charged earlier than a vehicle 40 for which at least either first charging environment information or second charging environment information is set to T. The order deciding unit 230 decides an order such that a vehicle 40 for which either first charging environment information or second charging environment information is set to T is charged earlier than a vehicle 40 for which both first charging environment information and second charging environment information are set to T. The order deciding unit 230 may decide an order such that a vehicle 40 for which only first charging environment information is set to F is charged earlier than a vehicle 40 for which only second charging environment information is set to F.

Thereby, vehicles 40 of users to whom charging devices are not available at their homes or parking lots of their workplaces can be given higher priorities in terms of charging. Because of this, convenience for users to whom charging devices are not available can be enhanced.

Next, specific examples of operation of the charging management unit 240 are explained. With reference to FIG. 3, an example in which a vehicle 40 with a user ID “A” is charged is explained. The owner of the vehicle 40 with the user ID “A” wishes to charge the vehicle 40 with the amount of power of 5 kWh by 14:30. A vehicle 40 with a user ID “B” has sufficient power for discharging an amount of power of 5 kWh until 14:00. According to the discharging requirements about the dischargeable power and discharging time of the vehicle 40 with the user ID “B”, the charging requirements about the charging power and charging time of the vehicle 40 with the user ID “A” can be met. Accordingly, the charging management unit 240 determines that the discharging power and discharging time of the vehicle 40 with the user ID “B” match the charging power and charging time of the vehicle 40 with the user ID “A”. The charging management unit 240 instructs the vehicle 40 with the user ID “A” and the vehicle 40 with the user ID “B” to charge the vehicle 40 with the user ID “A” by 14:00 with the amount of charging power of 5 kWh being set as the upper limit.

Next, an example in which a vehicle 40 with a user ID “C” is charged is explained. The owner of the vehicle 40 with the user ID “C” wishes to charge the vehicle 40 with the amount of power of 8 kWh by 14:30. The vehicle 40 with a user ID “B” has sufficient power for discharging an amount of power of 5 kWh until 14:00. The discharging requirements about the dischargeable power and discharging time of the vehicle 40 with the user ID “B” only partially meet the charging requirements about the charging power and charging time of the vehicle 40 with the user ID “C”. In this case, the charging management unit 240 decides to charge the vehicle 40 with the user ID “C” only to the extent allowed by the discharging requirements of the vehicle 40 with the user ID “B”. Specifically, the charging management unit 240 instructs the vehicle 40 with the user ID “C” and the vehicle 40 with the user ID “B” to charge the vehicle 40 with the user ID “C” by 14:00 with the amount of charging power of 5 kWh being set as the upper limit.

Note that, before starting charging, the charging management unit 240 may confirm with a user through the vehicle-side device 50 of the to-be-charged vehicle 40 whether or not he/she permits charging to be carried out not to exceed the upper limit of the amount of charging power of 5 kWh. The charging management unit 240 may instruct the vehicle 40 with the user ID “C” and the vehicle 40 with the user ID “B” to carry out charging under a condition that confirmation by the user is given.

Next, an example in which a vehicle 40 with a user ID “D” is charged is explained.

The owner of the vehicle 40 with the user ID “D” requests to charge the vehicle 40 with the amount of power of 3 kWh by 13:30. The vehicle 40 with a user ID “B” has sufficient power for discharging an amount of power of 5 kWh until 14:00. The discharging requirements about the dischargeable power and discharging time of the vehicle 40 with the user ID “B” meet the charging requirements about the charging power and charging time of the vehicle 40 with the user ID “D”. Accordingly, the charging management unit 240 determines that the discharging power and discharging time of the vehicle 40 with the user ID “B” match the charging power and charging time of the vehicle 40 with the user ID “D”. The charging management unit 240 decides to discharge power from the vehicle 40 with the user ID “B” only to the extent allowed by the charging requirements of the vehicle 40 with the user ID “D”. Specifically, the charging management unit 240 instructs the vehicle 40 with the user ID “D” and the vehicle 40 with the user ID “B” to charge the vehicle 40 with the user ID “D” by 13:30 with the amount of charging power of 3 kWh being set as the upper limit.

In this manner, the charging management unit 240 causes power transfer to be performed between two vehicles 40 such that charging requirements about an amount of charging power and a charging time of one of the vehicles 40 can be met as much as possible only to the extent discharging requirements about a dischargeable power amount and dischargeable time of the other vehicle 40 are met. Time permitted for charging or discharging can be acquired from a smartphone, another PDA or the like carried by a user of a parking lot. In addition, time permitted for charging or discharging can be acquired by referring to positional information about a user of a parking lot. For example, it is possible to infer, from positional information about a user who uses a parking lot located in an area around a railway station, remaining time until when the user will next return to the parking lot, and move the vehicle 40. In addition, it is possible to enhance the precision of inference about time permitted for charging or discharging since it can be determined whether the user will use railways based on positional information about a user of a parking lot.

Note that if the user with the user ID “B” moves his/her vehicle 40 from a parking section 12 before completion of charging of the vehicle 40 which is being charged, charging of the vehicle 40 cannot completed in some cases. In view of this, the benefit granting unit 250 may grant a benefit to the user with the user ID “B” if the user with the user ID “B” kept the vehicle 40 parked until a scheduled usage end time.

For example, the benefit granting unit 250 may discount the usage fee of the parking lot 10. In addition, the benefit granting unit 250 may exempt the user from payment of an additional usage fee of the parking lot 10 that is charged for an extra length of time during which the vehicle 40 is parked after the scheduled usage end time. The benefit granting unit 250 may discount a facility usage fee of a commercial facility associated with the parking lot 10. For example, if the temporal difference between a usage start time and a scheduled usage end time that are associated with the user ID “B” is equal to or longer than three hours, the benefit granting unit 250 may transmit a discount coupon for movie tickets to a mobile terminal of the user with the user ID “B”. If the temporal difference between a usage start time and a scheduled end time that are associated with the user ID “B” is shorter than one hour, the benefit granting unit 250 may transmit a beverage voucher that can be used at restaurants in a commercial facility to a mobile terminal of the user with the user ID “B”. In this manner, the benefit granting unit 250 may grant benefits according to the temporal differences between usage start times and scheduled end times. Thereby, the possibility of the schedule of charging/discharging between vehicles 40 being disturbed can be lowered.

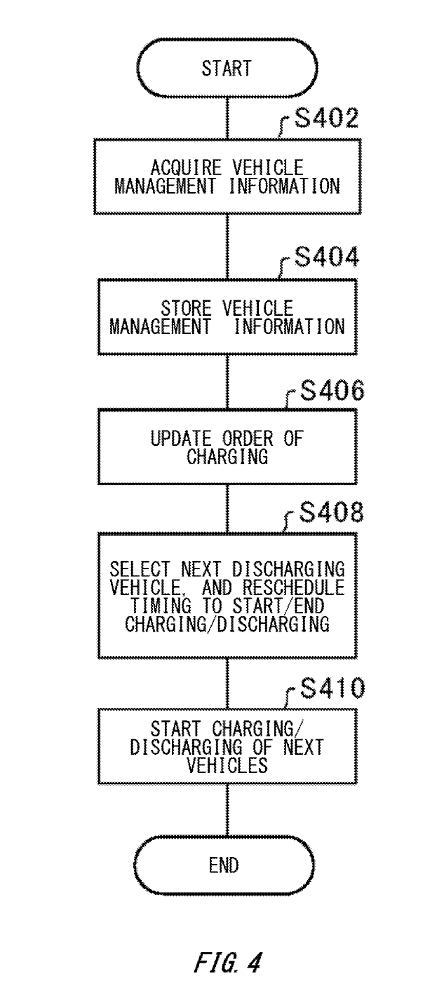

FIG. 4 is an exemplary flowchart showing processes performed at the charging management device 100. Processes in the flowchart shown in FIG. 4 are executed repeatedly. For example, the processes in the flowchart shown in FIG. 4 are performed every time the charging management device 100 receives vehicle information from each vehicle.

At S402, the information acquiring unit 210 acquires vehicle management information through the vehicle-side device 50 or power line 20. At S404, the storage unit 280 stores the vehicle management information.

At S406, based on information stored in the storage unit 280, the order deciding unit 230 updates the order in which vehicles 40 are charged. At S408, based on the updated order, the charging management unit 240 selects a vehicle 40 to be the next discharging vehicle, and reschedules timing to start and timing to end charging/discharging to be carried between vehicles 40. At S410, upon completion of charging that is currently being executed, charging of a vehicle 40 is started according to the order updated at S406 and at timing rescheduled at S408.

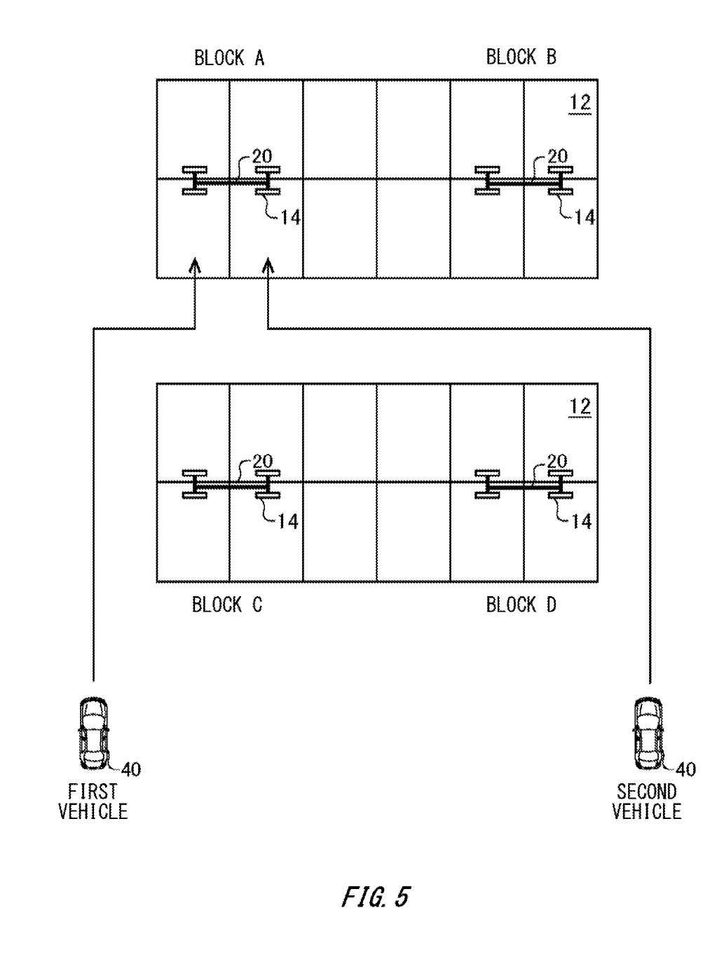

FIG. 5 schematically illustrates another exemplary usage form of parking sections. In the example of parking sections 12 shown in FIG. 1, all the connectors 14 located in the plurality of parking sections 12 provided to the parking lot 10 are connected to one power line 20. In the parking lot shown in FIG. 5, a predetermined number of connectors 14 are provided in each parking section 12, and a predetermined number of power lines 20 are provided independently in each parking section 12. Specifically, the parking lot 10 is provided with a parking block A, a parking block B, and a parking block C.

It is supposed here that it is set, in a vehicle-side device 50 of the first vehicle 40 that arrived at the parking lot, that the vehicle 40 requests charging or has sufficient power for discharging power. In this case, the guidance information generating unit 260 may guide the vehicle 40 such that the vehicle 40 is parked at any of the parking block A, parking block B, and parking block C. For example, the guidance information generating unit 260 transmits, to the vehicle-side device 50, guidance information indicating a traveling route for guiding the vehicle 40 to any of the parking block A, parking block B, and parking block C.

Next, an example in which the second vehicle 40 is guided is explained. It is supposed in explanations here that the first vehicle 40 requests charging with an amount of power of 5 kWh, and is parked at the parking block A. If it is set, in the vehicle-side device 50 of the second vehicle 40, that the second vehicle 40 has sufficient power for discharging an amount of power of 5 kWh, the guidance information generating unit 260 transmits guidance information for guiding the second vehicle 40 to the parking block A. Thereby, charging with/discharging of a desirable amount of power can be carried out between the first vehicle 40 and the second vehicle 40.

Note that, in the example shown in FIG. 5, for the sake of easy-to-understand explanation, an example in which the first vehicle 40 and second vehicle 40 are guided is explained. However, if a plurality of vehicles 40 are parked in each parking block already, and another vehicle 40 which is about to be parked is guided, guidance information may be generated such that the power supply and demand about charging/discharging are balanced out in each parking block. For example, if another vehicle 40 which is about to be parked has sufficient power for discharging power, guidance information may be generated such that the vehicle 40 is guided to a parking block having the largest power amount difference which is obtained by subtracting the total of dischargeable power amounts from the total of amounts of charging power being requested. If another vehicle 40 which is about to be parked is requesting charging, guidance information may be generated such that the vehicle 40 is guided to a parking block having the smallest power amount difference which is obtained by subtracting the total of dischargeable power amounts from the total of amounts of charging power being requested. In addition, even if a plurality of parking sections 12 are dispersedly located, the guidance information generating unit 260 can transmit, to vehicle-side devices 50 of vehicles 40, guidance information indicating traveling routes for guiding the vehicles 40 to respective parking blocks. Thereby, it becomes possible to balance out the power supply and demand about charging/discharging in each parking block.

As has been explained above, according to the charging management device 100, the order in which vehicles 40 parked in the parking lot 10 are charged can be decided taking into consideration the charging environments of the vehicles 40. In addition, since vehicles 40 can perform power transfer directly therebetween, it is not necessary to provide large power transformation equipment in the parking lot 10.

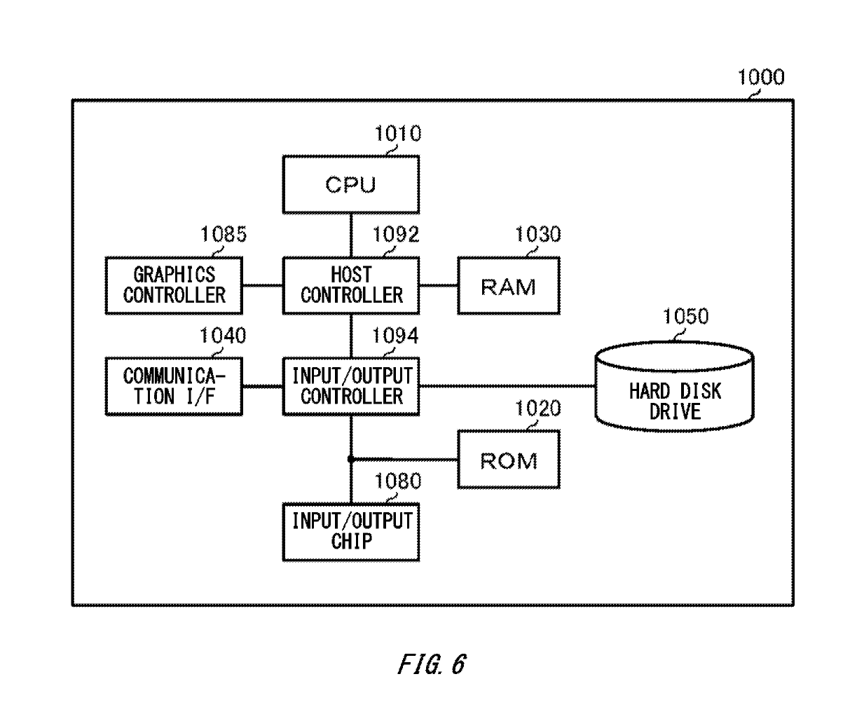

FIG. 6 generally illustrates an exemplary computer 1000 to function as the charging management device 100. The computer 1000 according to the present embodiment includes: a CPU peripheral section having a CPU 1010, a RAM 1030, and a graphics controller 1085 that are interconnected by a host controller 1092; and an input/output section having a ROM 1020, a communication I/F 1040, a hard disk drive 1050, and an input/output chip 1080 that are connected to the host controller 1092 by an input/output controller 1094.

The CPU 1010 performs operation based on programs stored in the ROM 1020 and RAM 1030, and performs control of each unit. The graphics controller 1085 acquires image data generated by the CPU 1010 or the like on a frame buffer provided in the RAM 1030, and displays the image data on a display. Instead of this, the graphics controller 1085 may include therein a frame buffer to store image data generated by the CPU 1010 or the like.

The communication I/F 1040 communicates with another device via a network through a wired or wireless connection. In addition, the communication I/F 1040 functions as hardware to perform communication. The hard disk drive 1050 stores programs and data to be used by the CPU 1010.

The ROM 1020 stores a boot-program to be executed by the computer 1000 at the time of activation and programs or the like that depend on hardware of the computer 1000. The input/output chip 1080 connects various types of input/output devices to the input/output controller 1094 via, for example, a parallel port, a serial port, a keyboard port, a mouse port, and the like.

Programs to be provided to the hard disk drive 1050 via the RAM 1030 are provided by a user in the form stored in a recording medium such as an IC card. The programs are read out of the recording medium, installed on the hard disk drive 1050 via the RAM 1030, and executed at the CPU 1010.

The programs that are installed on the computer 1000, and make the computer 1000 function as the charging management device 100 may act on the CPU 1010 or the like to make the computer 1000 function as each unit of the charging management device 100. Information processing described in these program are read into the computer 1000 to thereby make the computer 1000 function as: the communicating unit 200; the information acquiring unit 210 having the environment information acquiring unit 212 and charging/discharging demand acquiring unit 214; the order deciding unit 230; the charging management unit 240; the benefit granting unit 250; the guidance information generating unit 260; and the storage unit 280, which are specific means attained by cooperation between software and various types of hardware resources mentioned above. With these specific means, the distinctive charging management device 100 corresponding to a purpose of use of the computer 1000 in the present embodiment can be configured by realizing calculations or processing of information corresponding to the purpose of use.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: parking lot
12: parking section
14: connector
18: charging cable
20: power line
40: vehicle
50: vehicle-side device
90: network
100: charging management device
200: communicating unit
210: information acquiring unit
212: environment information acquiring unit
214: charging/discharging demand acquiring unit
230: order deciding unit
240: charging management unit
250: benefit granting unit
260: guidance information generating unit
280: storage unit
1000: computer
1010: CPU
1020: ROM
1030: RAM
1040: communication I/F
1050: hard disk drive
1080: input/output chip
1085: graphics controller
1092: host controller
1094: input/output controller

What is claimed is:

1. A charging management device comprising:
an environment information acquiring unit that acquires charging environment information indicating a charging environment of each of a plurality of vehicles parked in a parking lot;
an order deciding unit that decides an order in which the plurality of vehicles are charged, taking into consideration the charging environment indicated by the charging environment information; and
a charging management unit that causes the plurality of vehicles to be charged according to the order decided by the order deciding unit.

2. The charging management device according to claim 1, further comprising a charging/discharging demand acquiring unit that acquires in advance: an amount of charging power requested by each of vehicles that are among the plurality of vehicles and request charging; and a dischargeable power amount at each of dischargeable vehicles among the plurality of vehicles, wherein
based on information acquired by the charging/discharging demand acquiring unit, the charging management unit selects, from among the plurality of vehicles, a second vehicle that has sufficient power for discharging an amount of power that matches the amount of charging power requested by a first vehicle which is one of the plurality of vehicles selected according to the order, and the charging management unit causes the first vehicle to be charged with power discharged from the second vehicle.

3. The charging management device according to claim 2, wherein
the charging/discharging demand acquiring unit acquires in advance: an amount of charging power requested by each of the vehicles requesting charging; a charging period during which the charging is requested to be carried out; and a dischargeable power amount and a dischargeable period of each of the dischargeable vehicles, and
based on information acquired by the charging/discharging demand acquiring unit, the charging management unit selects, as the second vehicle from among the plurality of vehicles, a vehicle that has sufficient power for discharging the amount of charging power requested by the first vehicle in the charging period.

4. The charging management device according to claim 3, further comprising:
a benefit granting unit that grants a vehicle among the dischargeable vehicles a benefit related to a usage fee of the parking lot or usage of a commercial facility associated with the parking lot if the vehicle remains stopped in the parking lot for the dischargeable period thereof.

5. The charging management device according to claim 2, wherein the first vehicle and the second vehicle are connected through a power line provided in the parking lot, and power is directly transferred between the first vehicle and the second vehicle through the power line.

6. The charging management device according to claim 5, wherein the charging management unit causes power to be directly transferred only between the first vehicle and the second vehicle in a one-to-one correspondence among a plurality of vehicles connected to the power line.

7. The charging management device according to claim 5, wherein
each of a plurality of parking sections in the parking lot is provided with at least one connector to which a charging cable for charging a vehicle is connectable, and
the at least one connector includes a plurality of connectors that are connected to the power line.

8. The charging management device according to claim 5, wherein the power line is provided independently for a predetermined number of parking sections.

9. The charging management device according to claim 2, further comprising:
a guidance information generating unit that generates information for guiding a vehicle that has sufficient power for discharging an amount of power matching an amount of charging power requested by a vehicle among the vehicles requesting charging, to a parking position near a position where the vehicle requesting charging is parked.

10. The charging management device according to claim 9, wherein
the parking lot is provided with independent power lines respectively corresponding to a plurality of section groups each including a plurality of parking sections, and each power line establishes a connection between vehicles parked in a plurality of parking sections included in a corresponding section group, and
the guidance information generating unit generates information for guiding a vehicle that has sufficient power for discharging an amount of power matching an amount of charging power requested by a vehicle among the vehicles requesting charging, to another parking section included in a section group including a parking section where the vehicle requesting charging is parked.

11. The charging management device according to claim 1, wherein the charging environment information includes information indicating whether or not parking lots associated with the plurality of vehicles have charging facilities.

12. The charging management device according to claim 11, wherein the order deciding unit decides an order in which the plurality of vehicles are charged, taking into consideration the charging environment indicated by the charging environment information, and a state of charge of a battery provided to each of the plurality of vehicles.

13. The charging management device according to claim 1, wherein
the charging environment information includes information indicating whether or not each of a plurality of parking lots associated with the plurality of vehicles has a charging facility, and
the order deciding unit decides the order such that a vehicle is charged earlier if the number of parking lots associated with the vehicle which are among the plurality of associated parking lots and have charging facilities is smaller.

14. A parking lot comprising the charging management device according to claim 1.

15. A non-transitory computer-readable storage medium having stored thereon a program for causing a computer to function as:
an environment information acquiring unit that acquires charging environment information indicating a charging environment of each of a plurality of vehicles parked in a parking lot;
an order deciding unit that decides an order in which the plurality of vehicles are charged, taking into consideration the charging environment indicated by the charging environment information; and
a charging management unit that causes the plurality of vehicles to be charged according to the order decided by the order deciding unit.
